(19) United States
(12) Patent Application Publication
(10) Pub. No.: US 2007/0164986 A1
(43) Pub. Date: Jul. 19, 2007

(54) Interface apparatus and method using electronic paper

(75) Inventors: Moon sik Jeong, Seongnam-si (KR); Woo-jong Cho, Suwon-si (KR); Chang-su Kim, Suwon-si (KR); Dong-kyung Nam, Yongin-si (KR); Yong-gook Park, Yongin-si (KR); Jung-hyun Shim, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/523,585

(22) Filed: Sep. 20, 2006

(30) Foreign Application Priority Data
Jan. 16, 2006 (KR) 10-2006-0004413

(51) Int. Cl. G09G 5/00

(52) U.S. Cl. 345/156

(57) ABSTRACT

An interface apparatus with: a display module having a plurality of display devices that display an image using electronic paper, a control module that provides enable information needed to enable the respective display devices and image information needed to display the image, a decoding module that decodes the enable information and sequentially transmits the decoded enable information to the display devices, and a graphic processing module that receives the image information from the control module and sequentially transmits the image information to the display devices, wherein the image information is displayed by one or more of the display devices that are enabled according to the enable information.

### CROSS-REFERENCE TO RELATED APPLICATIONS

This application claims the benefit of Korean Patent Application No. 10-2006-0004413 filed on Jan. 16, 2006 in the Korean Intellectual Property Office, the disclosure of which is incorporated herein by reference.

### BACKGROUND OF THE INVENTION

1. Field of the Invention

The present invention relates to a user interface using electronic paper and, more particularly, to an interface apparatus and method that can display an image on a plurality of display devices using the bi-stability of electronic paper.

2. Description of Related Art

In general, if button display information can be freely modified using display means for buttons, necessary information can be effectively provided to users in various manners according to the circumstances facing the users. In this case, it is possible to reduce the number of buttons required and to provide users with a more efficient button use environment by realizing a more intuitive button display. Accordingly, research has been vigorously conducted to develop display buttons.

To provide a display button, an image display screen that is large enough to display a display button, a driving module that drives the image display screen, and a graphic processing module that transmits image information to the driving module are needed.

And to provide a display button apparatus with a plurality of display buttons, an image display screen, the driving module, and a graphic processing module must be mounted on each of the display buttons. This mounting process, however, is very complicated, thus making it difficult to manufacture display button apparatuses with respective pluralities of buttons.

In the case of a display button apparatus using a non-luminescent display device such as a liquid crystal display (LCD) device, a backlight element must also be manufactured for and then mounted on each of a plurality of display buttons.

In the meantime, luminescent display devices such as organic light emitting diode (OLED) devices do not use backlight and can be driven manually. In this regard, luminescent display devices are appropriate for application to display buttons. But as the number of display buttons increases and the amount of image information that needs to be processed increases, such luminescent display devices may not be driven properly simply using a manual driving method. Also, as a plurality of pieces of image information need to be displayed on an image display screen provided for each of a plurality of display buttons increases, the number of connection lines required increases, and the manufacture of display button apparatuses becomes complicated.

Therefore, it is necessary to develop an interface apparatus and method that can considerably reduce the number of connection lines (e.g., image signal lines) required, facilitate the manufacture of display buttons, and easily control image information displayed by display buttons.

### BRIEF SUMMARY

An aspect of the present invention provides an interface apparatus that sequentially applies image information for a plurality of display buttons by using the bi-stability of electronic paper.

An aspect of the present invention also provides an interface apparatus and method that can reduce the number of connection lines needed to drive a plurality of display buttons.

An aspect of the present invention also provides an interface apparatus and method capable of controlling a plurality of display buttons to display images by using a single graphic processing module.

According to an aspect of the present invention, there is provided an interface apparatus, including: a display module, which includes a plurality of display devices that display an image using electronic paper; a control module, which provides enable information needed to enable the respective display devices and image information needed to display the image; a decoding module, which decodes the enable information and sequentially transmits the decoded enable information to the display devices; and a graphic processing module, which receives the image information from the control module and sequentially transmits the image information to the display devices, wherein the image information is displayed by one or more of the display devices that are enabled according to the enable information.

According to another aspect of the present invention, there is provided an interface apparatus, including: a display module, which includes a plurality of display devices that display an image using electronic paper; a control module, which provides enable information needed to enable the respective display devices and image information needed to display the image; and a graphic processing module, which receives the image information from the control module and sequentially transmits the image information to the display devices, wherein each of the display devices includes a decoding module that decodes the enable information and sequentially transmits the decoded enable information to the display devices, and the image information is displayed by one or more of the display devices that are enabled according to the enable information.

According to another aspect of the present invention, there is provided an interface apparatus, including: a display module, which includes a plurality of display buttons that display an image using electronic paper and sense user input; an input sensing module, which chooses one or more of the display buttons that are determined to have been pressed by a user according to the sensed user input; a control module, which provides enable information needed to enable the one or more chosen display buttons and image information needed to display an image; a decoding module, which decodes the enable information and sequentially transmits the decoded enable information to the display buttons; and a graphic processing module, which receives the image information from the control module and sequentially transmits the image information to the display buttons, wherein the image information is displayed by one or more of the display buttons that are enabled according to the enable information.

According to another aspect of the present invention, there is provided an interface apparatus, including: a display module, which includes a plurality of display buttons that display an image using electronic paper and sense user input; an input sensing module, which chooses one or more of the display buttons that are determined to have been pressed by a user according to the sensed user input; a control module, which provides enable information needed to enable the one or more chosen display buttons and image information needed to display an image; a graphic processing module, which receives the image information from the control module and sequentially transmits the image information to the display buttons, wherein each of the display buttons includes a decoding module which decodes the enable information and sequentially transmits the decoded enable information to the display buttons, and the image information is displayed by one or more of the display buttons that are enabled according to the enable information.

According to another aspect of the present invention, there is provided an interface apparatus, including: a button unit, which senses user input; an image display unit, which displays image information corresponding to the sensed user input on electronic paper; and a connection unit, which connects the button unit and the image display unit.

According to another aspect of the present invention, there is provided an interface apparatus, including: a display array, which includes a plurality of display buttons that display image information using electronic paper; an input sensing module, which determines which of the display buttons is selected by a user; and an image display circuit, which provides the display array with image information corresponding to the display button that is determined to be selected by the user and a select signal to select the display button that is determined to be selected by the user.

According to another aspect of the present invention, there is provided an interface method, including: sensing user input from a plurality of display buttons that display an image using electronic paper, and selecting one or more of the display buttons that are pressed by a user; sequentially providing enable information needed to enable the selected display buttons to the display buttons; and sequentially providing image information needed to display a predetermined image to the display devices, and displaying the image information on one or more of the display buttons that are enabled according to the enable information.

According to another aspect of the present invention, there is provided an interface method, including: providing enable information needed to enable one or more of a plurality of display devices and image information needed to display an image, the display devices displaying the image using electronic paper; decoding the enable information and sequentially transmitting the decoded enable information to the display devices; and displaying the image information on the one or more of the display devices that are enabled according to the decoded enable information.

According to another aspect of the present invention, there is provided an interface method, including: providing enable information needed to enable one or more of a plurality of display devices and image information needed to display an image, the display devices displaying the image using electronic paper; decoding the enable information,; sequentially transmitting the image information to the display devices, and displaying the image information on the one or more of the display devices that are enabled according to the decoded enable information.

Additional and/or aspects and advantages of the present invention will be set forth in part in the description that follows and, in part, will be apparent from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings, of which:

FIG. 1 is a block diagram of an interface apparatus according to an embodiment of the present invention;

FIG. 2 is a block diagram of an interface apparatus according to another embodiment of the present invention;

FIG. 3 is a block diagram of an interface apparatus according to another embodiment of the present invention;

FIGS. 4A and 4B regard an example of the operation of the interface apparatus illustrated in FIG. 2;

FIGS. 5A and 5B regard another example of the operation of the interface apparatus illustrated in FIG. 2;

FIGS. 6A and 6B regard another example of the operation of the interface apparatus illustrated in FIG. 2;

FIGS. 7A and 7B regard another example of the operation of the interface apparatus illustrated in FIG. 2;

FIGS. 8A and 8B are block diagrams of interface apparatuses according to embodiments of the present invention;

FIG. 9 is a flowchart illustrating an interface method according to an embodiment of the present invention;

FIG. 10 is a view of a display button according to an embodiment of the present invention;

FIGS. 11A and 11B regard a display button input operation according to an embodiment of the present invention;

FIGS. 12A and 12B illustrate an arrangement of input signal lines to detect a display button input according to an embodiment of the present invention;

FIGS. 13A and 13B illustrate architecture to sense an input from a display array that has a plurality of display buttons according to an embodiment of the present invention;

FIGS. 14A through 14C illustrate an arrangement of an image drive line of the display button according to an embodiment of the present invention;

FIG. 15 illustrates architecture to provide a display array that has a plurality of display buttons to display an image according to an embodiment of the present invention;

FIGS. 16A through 16B illustrate the structure of an image display unit of a display button according to an embodiment of the present invention;

FIG. 17 is an exploded perspective view of a display array that comprises a plurality of display buttons according to an embodiment of the present invention;

FIG. 18 illustrates a user interface that uses a plurality of display buttons according to an embodiment of the present invention;

FIG. 19 is an exploded perspective view of a display array that provides the user interface illustrated in FIG. 18; and

FIGS. 20A through 20C illustrate an interface apparatus using a plurality of display buttons according to another embodiment of the present invention.

### DETAILED DESCRIPTION

Reference will now be made in detail to embodiments of the present invention, examples of which are illustrated in the accompanying drawings, wherein like reference numerals refer to the like elements throughout. The embodiments are described to explain the present invention by referring to the figures.

The present invention is described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide operations implementing the functions specified in the flowchart block or blocks.

And each block of the flowchart illustrations may represent a module, segment, or portion of code that has one or more executable instructions to implement the specified logical function(s). It should also be noted that in some alternative implementations, the functions noted in the blocks may occur out of the Illustrated order. For example, two blocks shown in succession may in fact be executed substantially concurrently or the blocks may sometimes be executed in the reverse order, depending upon the functionality involved.

The term ‘module’, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

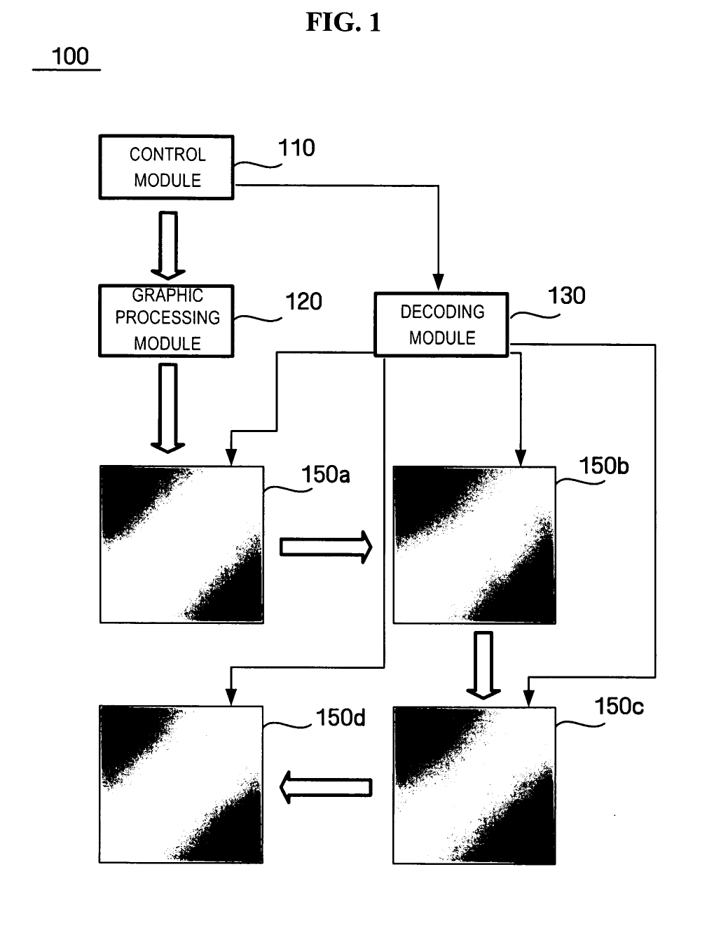

FIG. 1 is a block diagram of an interface apparatus 100 according to an embodiment of the present invention. Referring to FIG. 1, the interface apparatus 100 includes a control module 110, a graphic processing module 120, a decoding module 130, and one or more display devices 150a through 150d. The display devices 150a through 150d may be arranged in a matrix or an array. The arrangement of the display devices 150a through 150d will hereinafter be referred to as a display array.

The display devices 150a through 150d display images using electronic paper. Electronic paper is a display device that incorporates advantages of conventional display devices and advantages of paper documents. Electronic paper is a reflective display device that can provide a resolution as high as that of ink on paper, wide viewing angles, and a bright white background, and can be easily provided on any type of substrate, such as a plastic, metallic, or paper substrate.

Electronic paper can hold images for hours or for days, even after power is cut off, and is thus deemed bi-stable.

Examples of electronic paper include displays manufactured by Gyricon, a subsidiary of Xerox Corp., electrophoretic displays manufactured using microcapsules by E-Ink, and cholestric liquid crystal displays manufactured by Kent Display.

The control module 110 performs a control operation in order to distribute image information to each of the display devices 150a through 150d of the display array.

The graphic processing module 120 stores the image information provided by the control module 110 in a memory buffer, and then distributes the image information to each of the display devices 150a through 150d.

The decoding module 130 decodes enable information regarding the display array, which is needed to enable each of the display devices 150a through 150d. The interface apparatus 100 includes one decoding module (130).

The control module 110 provides the image information to the graphic processing module 120, and the graphic processing module 120 stores the image information in a memory buffer of the graphic processing module 120. The graphic processing module 120 is connected in series to the display devices 150a through 150d by image signal lines. The image information stored in the memory buffer of the graphic processing module 120 is sequentially transmitted to the display devices 150a through 150d via the image signal lines.

The image signal lines have four signal lines. Examples of the image signal lines include a signal line transmitting information regarding images displayed by the display devices 150a through 150d, a signal line supplying a power supply voltage, a signal line supplying a ground voltage, and a signal line transmitting a timing clock signal.

The decoding module 130 decodes enable information, which is provided by the control module 110 and is needed to enable the display array, and transmits the decoded enable information to each of the display devices 150a through 150d. According to one embodiment, the decoding module 130 includes as many output terminals as there are display devices and transmit the decoded enable information to the display devices 150a through 150d via the output terminals respectively corresponding to the display devices 150a through 150d. According to another embodiment, the decoding module 130 includes only one output terminal to which the display devices 150a through 150d are all connected, and transmit the decoded enable information to all the display devices 150a through 150d via the output terminal. In the latter case, to enable a plurality of display devices, the decoding module 130 sequentially outputs the decoded enable information as many times as the number of display devices that need to be enabled.

When the displaying of an image by a display device is concluded, the decoding module 130 turns off the display array using the enable information. Due to the bi-stability of electronic paper, an image that is displayed by a display device of a display array before the display array is turned off can be continuously displayed by the display device even after the display array is turned off.

The image displayed by each of the display devices 150a through 150d can be modified using the enable information.

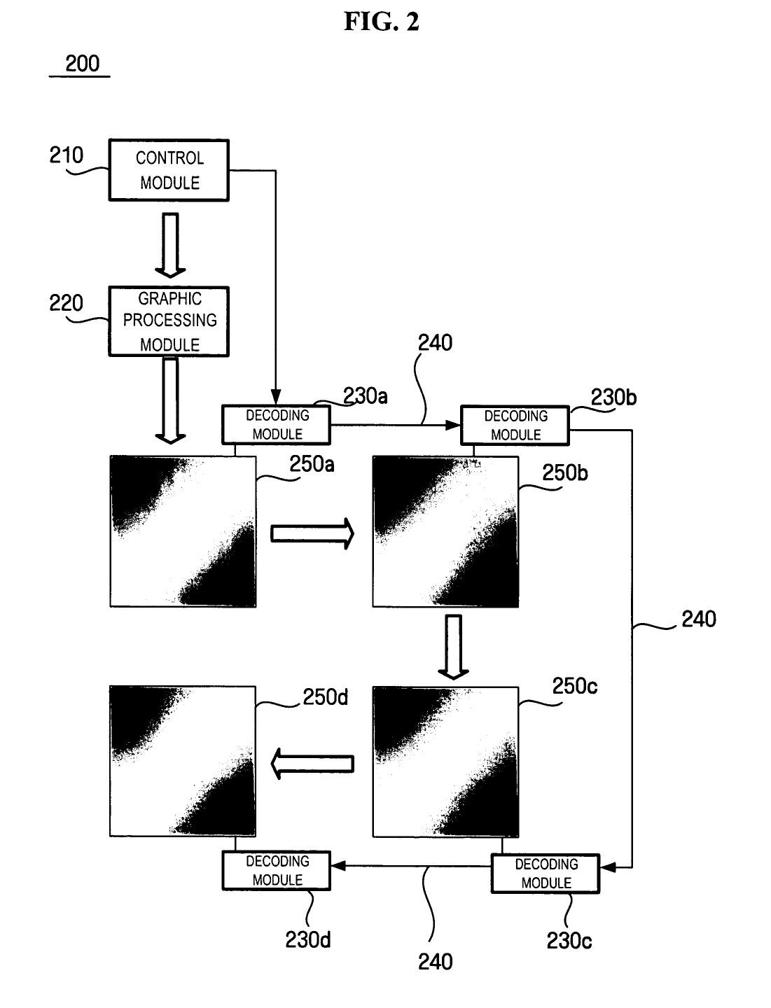

FIG. 2 is a block diagram of an interface apparatus 200 according to another embodiment of the present invention. Referring to FIG. 2, a plurality of decoding modules 230a through 230d are respectively installed in a plurality of display devices 250a through 250d, and thus, the number of decoding modules 230a through 230d is the same as the number of display devices 250a through 250d. A control module 210 and a graphic module 220 respectively correspond to the control module 110 and the graphic processing module 120 illustrated in FIG. 1, and the operations of the control module 210 and the graphic module 220 are similar to the operations of their respective counterparts. Thus, detailed descriptions of the control module 210 and the graphic module 220 will be skipped.

Enable information regarding a display array, which is provided by the control module 210, is decoded by the decoding module 230a and the decoded enable information is sequentially transmitted to the decoding modules 230b, 230c, and 230d via a plurality of serial data signal lines 240.

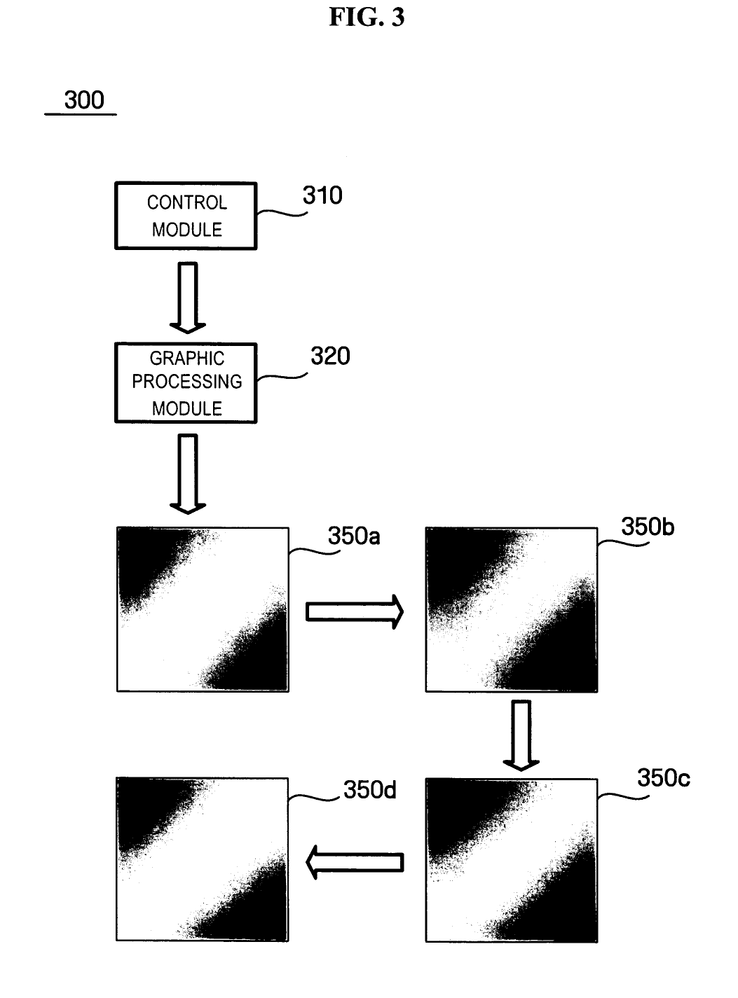

FIG. 3 is a block diagram of an interface apparatus 300 according to another embodiment of the present invention. Referring to FIG. 3, a control module 310 and a graphic processing module correspond to the control module 110 and the graphic processing module 120, respectively, illustrated in FIG. 1, and the control module 210 and the graphic processing module 220, respectively, illustrated in FIG. 2. The control module 310, unlike the control modules 110 and 210, provides both image information and enable information regarding a display array to the graphic processing module 320 at the same time. Then, the graphic processing module 320 provides the enable information as well as the image information to each of a plurality of display devices 350a through 350d. The enable information is decoded by a plurality of decoding modules (not shown) respectively included in the display devices 350a through 350d, thus enabling the display devices 350a through 350d.

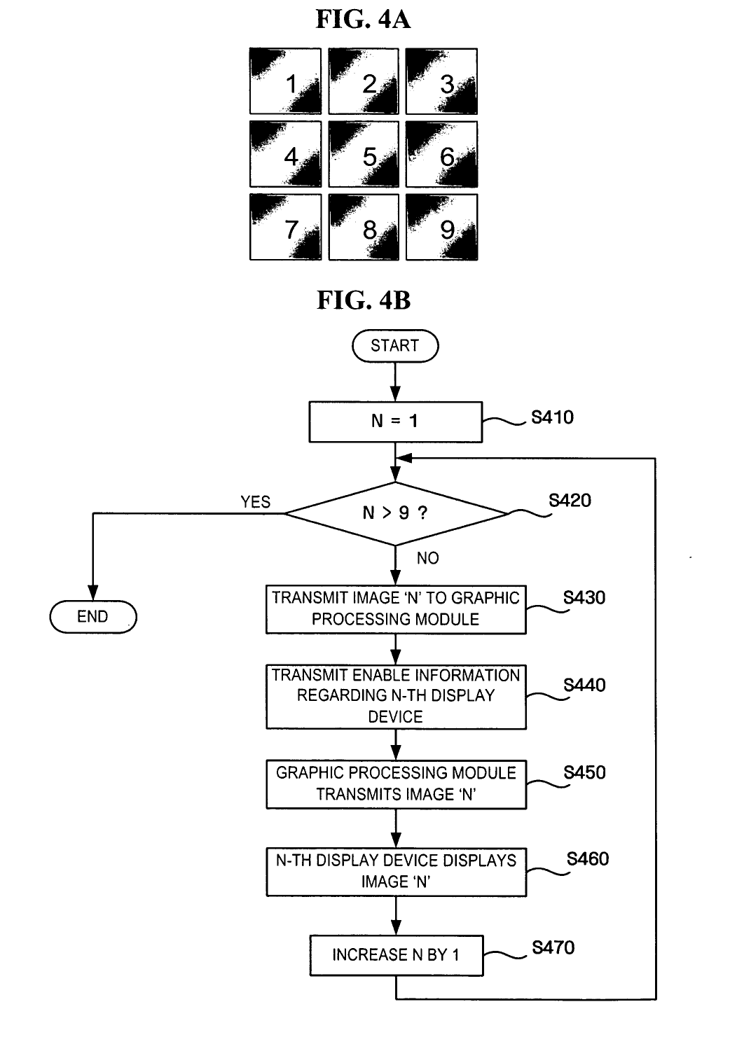

FIGS. 4A and 4B regard an operation of an interface apparatus according to an embodiment of the present invention, and this operation will hereinafter be described in detail with reference to the structure of the interface apparatus 200 illustrated in FIG. 2. For purposes of this example, it is assumed that the interface apparatus 200 includes a display array that has nine display devices even though the interface apparatus 200 is illustrated in FIG. 2 as having only four display devices.

FIG. 4A illustrates nine display devices, which are respectively numbered one through nine, and FIG. 4B illustrates a method of providing the situation illustrated in FIG. 4A.

Referring to FIG. 4B, in operation S410, an index variable N is set to an initial value of 1. The index variable N corresponds to the number of display devices of the display array of the interface apparatus 200.

In operation S420, the control module 210 determines whether the current value of the index variable N is greater than the number of display devices of the display array of the interface apparatus 200, i.e., whether the current value of the index variable N is greater than 9.

If it is determined in operation S420 that the current value of the index variable N is greater than 9, the method is complete. On the other hand, in operation S430, if it is determined in operation S420 that the current value of the index variable N is smaller than 9, the control module 210 transmits image ‘N’ to the graphic processing module 220. Thereafter, in operation S440, the control module 210 transmits enable information regarding an N-th display device to a decoding module installed in the first display device, and this enable information regarding the N-th display device is sequentially transmitted to a plurality of decoding modules respectively installed in the (N+1)-th through ninth display devices.

In operation S450, the graphic processing module 220 sequentially transmits image ‘N’ transmitted by the control module 210 to the first through ninth display devices. In operation S460, the decoding module installed in the N-th display device decodes the enable information, thereby enabling the N-th display device to display image ‘N’. In this case, the first through ninth display devices except the N-th display device are disabled, i.e., not enabled. Even if the control module 210 or the graphic processing module 220 is not driven any longer, image ‘N’ can be continuously displayed by the N-th display device due to the bi-stability of electronic paper that forms each of the first through ninth display devices.

Thereafter, in operation S470, the control module 210 increases the current value of the index variable N by 1, and the method returns to operation S420.

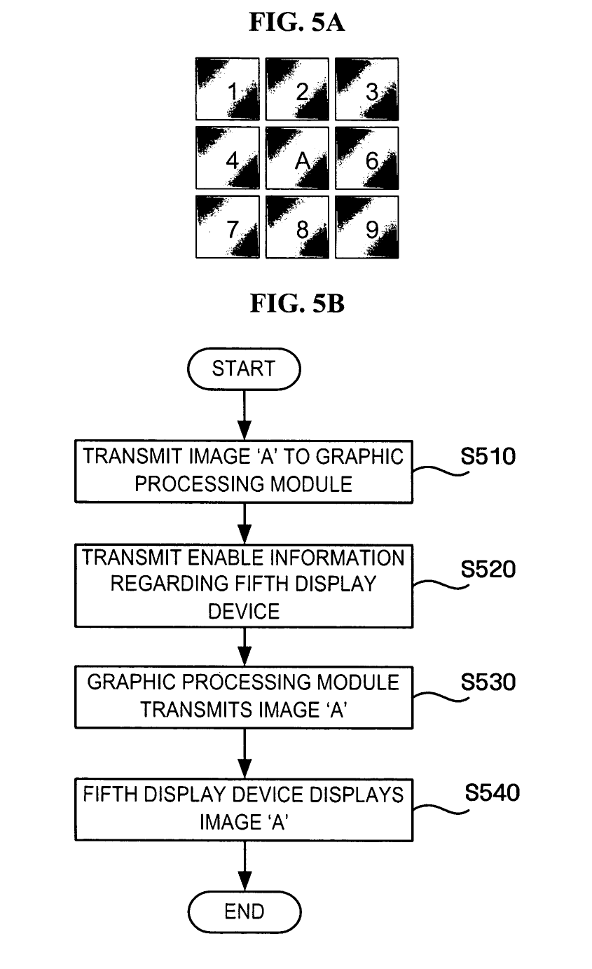

FIGS. 5A and 5B regard an operation of an interface apparatus according to another embodiment of the present invention, and this operation will hereinafter be described in detail with reference to the structure of the interface apparatus 200 illustrated in FIG. 2.

FIG. 5A illustrates that the fifth display device displays not image ‘5’ but image ‘A’, and FIG. 5B illustrates a method of providing the situation illustrated in FIG. 5A.

Referring to FIG. 5B, in operation S510, the control module 210 transmits image ‘A’ to the graphic processing module 220. In operation S520, the control module 210 transmits enable information regarding the fifth display device to the decoding module installed in the first display device, and then, this enable information regarding the fifth display device is sequentially transmitted to the decoding modules respectively installed in the first through ninth display devices.

In operation S530, the graphic processing module 220 sequentially transmits image ‘A’ transmitted by the control module 210. In operation S540, the decoding module installed in the fifth display device decodes the enable information, thereby enabling the fifth display device to display image ‘A’. In this case, the first through ninth display devices except the fifth display device are disabled, i.e., not enabled. Even if the control module 210 or the graphic processing module 220 is not driven any longer, image ‘A’ can be continuously displayed by the fifth display device due to the bi-stability of electronic paper that forms each of the first through ninth display devices.

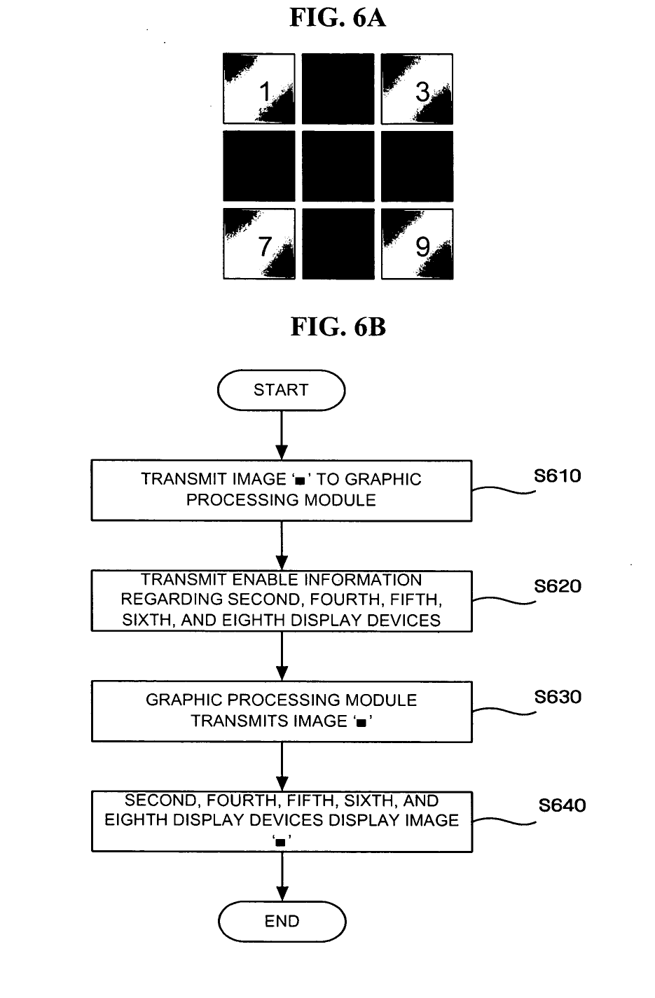

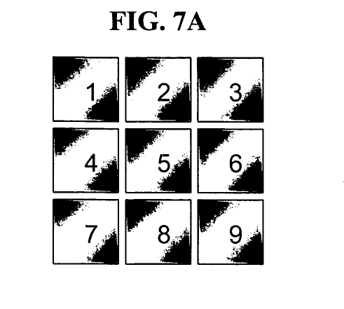

FIGS. 6A and 6B regard an operation of an interface apparatus according to another embodiment of the present invention, and this operation will hereinafter be described in detail with reference to the structure of the interface apparatus 200 illustrated in FIG. 2.

FIG. 6A illustrates that a cross is displayed using the first through ninth display devices, and FIG. 6B illustrates a method of providing the situation illustrated in FIG. 6A.

Referring to FIG. 6B, in operation S610, the control module 210 transmits image ‘▪’ to the graphic processing module 220. In operation S620, the control module 210 transmits enable information regarding the second display device to the decoding module installed in the first display device, and this enable information regarding the second display device is sequentially transmitted the decoding modules respectively installed in the first through ninth display devices. Also, in operation S620, once the enable information regarding the second display device is transmitted to the decoding module installed in the ninth display device, enable information regarding the fourth, fifth, sixth, and eighth display devices is sequentially transmitted by the control module 210 in the same manner as the enable information regarding the second display device.

In operation S630, the graphic processing module 220 sequentially transmits image ‘▪’ to the first through ninth display devices. In operation S640, the decoding modules respectively installed in the second, fourth, fifth, sixth, and eighth display devices decode the enable information, thereby enabling the second, fourth, fifth, sixth, and eighth display devices to display image ‘▪’. In this case, the other devices, i.e., the first, third, seventh, and ninth display devices, are disabled, i.e., not enabled. Even if the control module 210 or the graphic processing module 220 is not driven any longer, image ‘▪’ can be continuously displayed by the second, fourth, fifth, sixth, and eighth display devices due to the bi-stability of electronic paper that forms each of the first through ninth display devices.

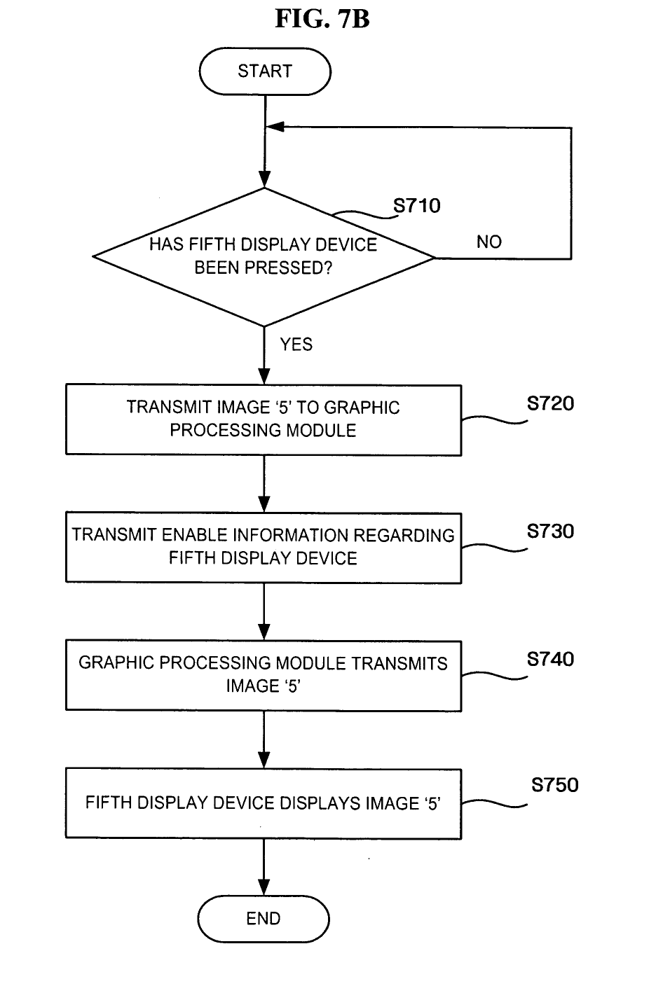

FIGS. 7A and 7B regard an operation of an interface apparatus according to an embodiment of the present invention, and this operation will hereinafter be described in detail with reference to the structure of the interface apparatus 200 illustrated in FIG. 2.

FIG. 7A illustrates the refreshing of image ‘5’ displayed by the fifth display device when image ‘5’ is damaged, and FIG. 7B illustrates a method of providing the situation illustrated in FIG. 7A.

Referring to FIG. 7B, in operation S710, the control module 210 determines whether the fifth display device has been pressed by a user.

In operation S720, if it is determined in operation S710 that the fifth display device has been pressed by the user, the control module 210 transmits image ‘5’ to the graphic processing module 220. In operation S730, the control module 210 transmits enable information regarding the fifth display device to the decoding module installed in the first display device, and this enable information regarding the fifth display device is sequentially transmitted to the decoding modules respectively installed in the first through ninth display devices.

In operation S740, the graphic processing module 220 sequentially transmits image ‘5’ transmitted by the control module 210 to the first through ninth display devices. In operation S750, the decoding module installed in the fifth display device decodes the enable information, thereby enabling the fifth display device to display image ‘5’. In this case, the first through ninth display devices, except the fifth display device, are disabled, i.e., not enabled. Even if the control module 210 or the graphic processing module 220 is not driven any longer, image ‘▪’ can be continuously displayed by the fifth display device due to the bi-stability of electronic paper that forms each of the first through ninth display devices.

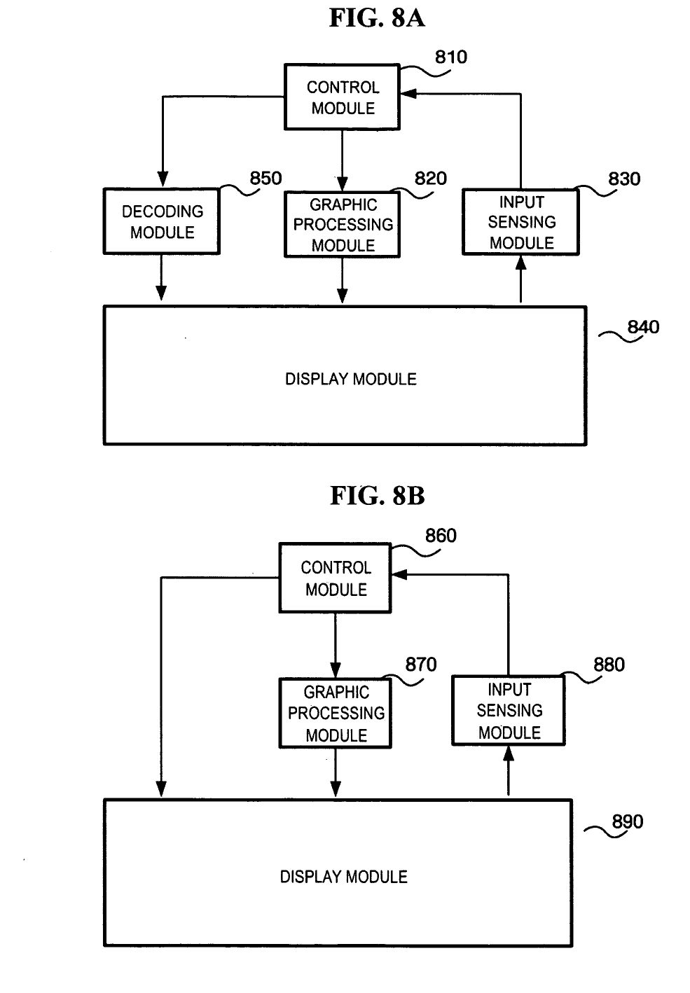

FIG. 8A is a block diagram of an interface apparatus according to another embodiment of the present invention. Referring to FIG. 8A, the interface apparatus includes a control module 810, a decoding module 850, a graphic processing module 820, an input sensing module 830, and a display module 840.

The display module 840 has a plurality of display devices that display images using electronic paper. The display devices may be arranged in a matrix or an array. Examples of the display devices include display buttons, and this will be described later in detail with reference to FIG. 10.

The control module 810, the decoding module 850, and the graphic processing module 820 respectively correspond to the control module 110, the decoding module 130, and the graphic processing module 120 illustrated in FIG. 1.

User input sensed by the display module 840 is transmitted to the input sensing module 830. The input sensing module 830 determines which of the display buttons of the display module 840 has been pressed by a user, and transmits the results of the determining to the control module 810. The control module 810 provides image information and enable information regarding the display button that is determined to have been pressed by the user, according to the results of the determining performed by the input sensing module 830, to the graphics processing module 820 and the decoding module 850, respectively.

FIG. 8B is a block diagram of an interface apparatus according to another embodiment of the present invention. Referring to the interface apparatus illustrated in FIG. 8B, a decoding module is installed in each of a plurality of display buttons of a display module 890. The control module 860 and the graphic processing module 870 respectively correspond to the control module 110 and the graphic processing module 120 illustrated in FIG. 1.

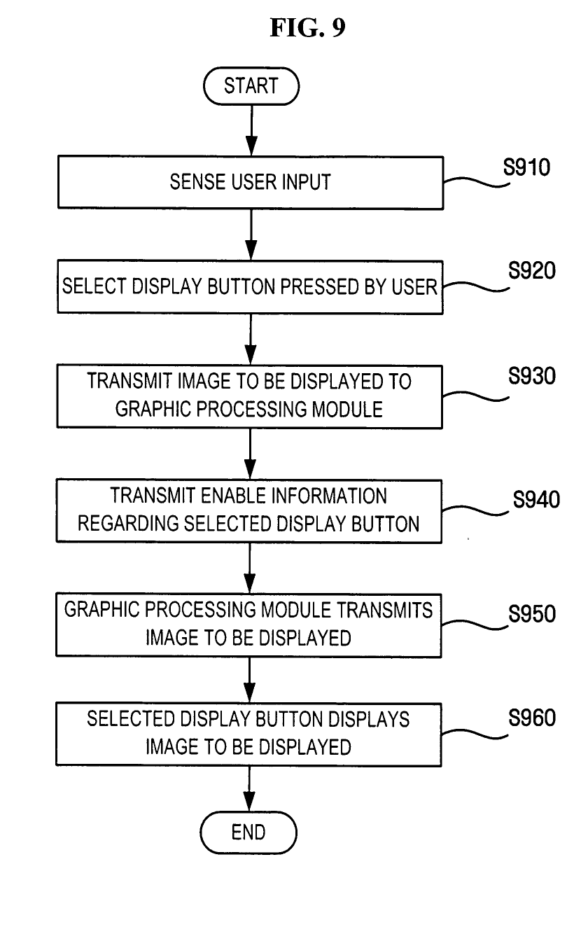

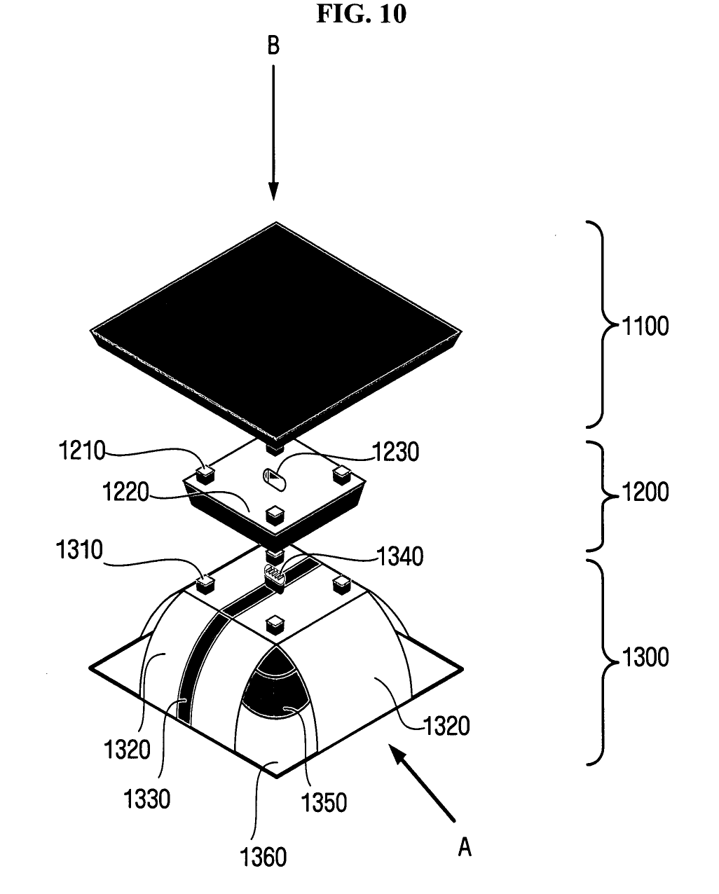

FIG. 9 is a flowchart illustrating an interface method according to an embodiment of the present invention. Referring to FIG. 9, in operation S910, the display module 840 senses user input. In operation S920, the input sensing module 830 determines which of the display buttons of the display module 840 has been pressed by a user, selects the display button that is determined to have been pressed by the user, and transmits the results of the determining to the control module 810.

In operation S930, the control module 810 transmits an image to be displayed to the graphic processing module 820. In operation S940, the control module 810 transmits enable information regarding the selected display button.

The enable information is decoded by a single decoding module, and the decoded enable information regarding the selected display button is sequentially transmitted to all the display buttons of the display module 840. If a plurality of decoding modules are respectively installed in the display buttons of the display module, e.g., as in the display module 890 of FIG. 8B, the decoding modules receive the enable information transmitted by the control module 810, and the decoding module installed in the display button determined to have been pressed by the user decodes the received enable information, thereby enabling the display button determined to have been pressed by the user.

In operation S950, the graphic processing module 820 sequentially transmits the image transmitted by the control module 810 to all the display buttons of the display module 840. The selected display button displays the image transmitted by the graphic processing module 820 on electronic paper according to the decoded enable information.

FIG. 10 is an exploded view of a display button according to an embodiment of the present invention. Referring to FIG. 10, the display button constitutes the display module 840 or 890 illustrated in FIG. 8A or 8B, respectively, and includes an image display unit 1100, a connection unit 1200, and a button unit 1300.

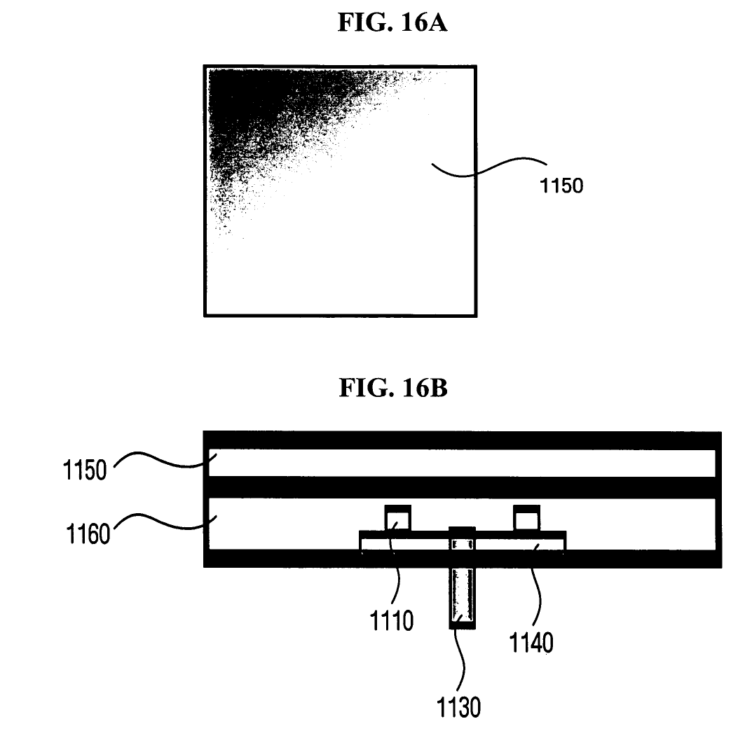

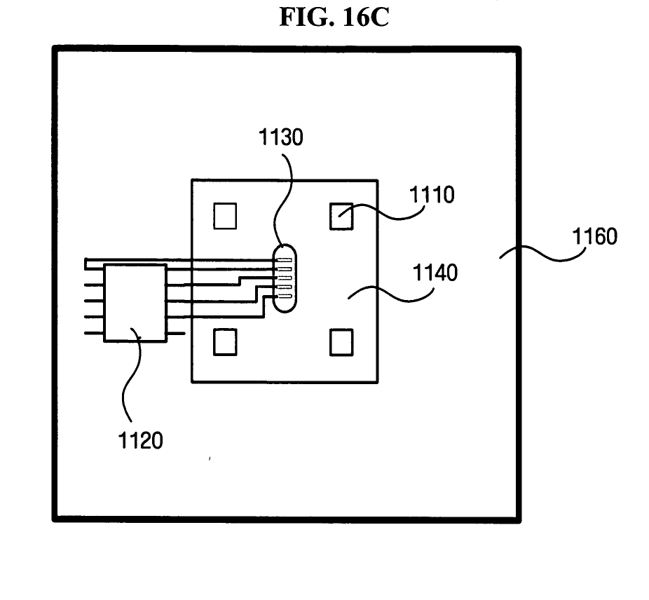

The image display unit 1100 is a module that can provide images with the aid of electronic paper, and includes an image unit 1150 that displays image information and an image driving unit 1160 that drives the imaging unit 1150. The image unit 1150 and the image driving unit 1160 will be described later in further detail with reference to FIGS. 16A through 16C.

The image display unit 1100 not only displays image information but also receives an input from a user.

The connection unit 1200 connects the button unit 1300 and the image display unit 1100. When the user presses the image display unit 1100, the connection unit 1200 transmits the pressure to the button unit 1300. To provide a user with an excellent tactile feeling when the user presses the display button, according to one embodiment, the connection unit 1200 is made of an elastic material, such as rubber or plastic.

The connection unit 1200 includes a press connector 1220, which alleviates shock generated when the button unit 1300 is pressed down, and a plurality of fixed protrusions 1210, which fix the press connector 1220 and the image display unit 1100.

A connector connection hole 1230 is formed at the center of the press connector 1220. The connector connection hole 1230 forms an empty space in which a connector 1340 of the button unit 1300 and a connector 1130 (see, e.g., FIG. 16B) of the image display unit 1100 can be connected. FIG. 10 illustrates the connector connection hole 1230 as being formed at the center of the press connector 1220. But the present invention is not restricted to this orientation.

The button unit 1300 includes a metallic plate 1320, which is elastically deformable and transmits a press feedback to the user by causing buckling (such as bends or curves) when the user presses the display button. The metallic plate 1320 extends in four directions across the center of the button unit 1300, and an image driving line 1330 is attached onto the metallic plate 1320. The image driving line 1330 is connected to the connector 1340.

Also, the button unit 1300 includes a plurality of fixed protrusions 1310 that fix the button unit 1300 and the connection unit 1200, a bottom plate 1360 that supports the connection unit 1200, and a conductive medium 1350 that receives a button input by being placed in contact with the metallic plate 1320 when the display button is pressed down by the user, and which alleviates shock. According to one embodiment, the conductive medium 1350 is made of conductive rubber.

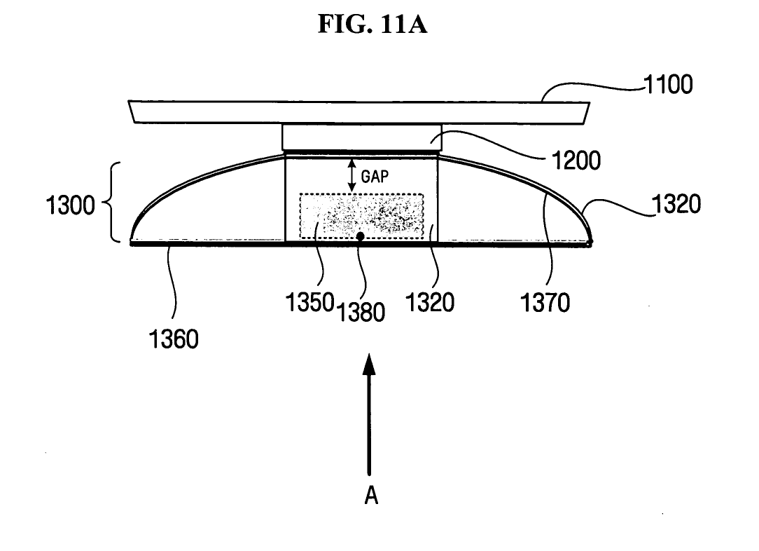

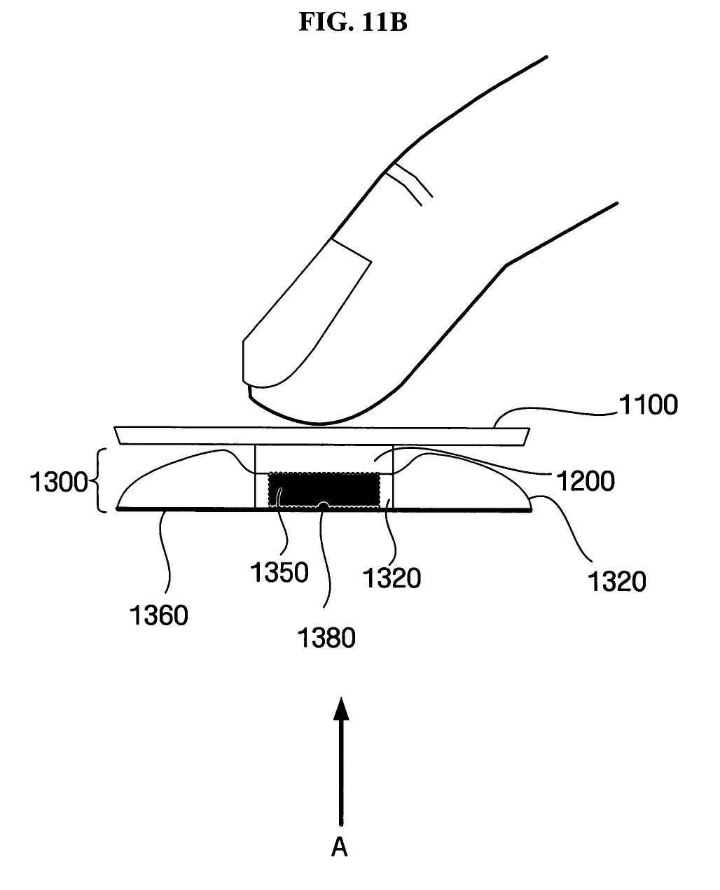

The button unit 1300 detects whether the metallic plate 1320 is placed in contact with the conductive medium 1350 by horizontal and vertical input signal lines 1370 and 1380 (see, e.g., FIG. 11A) that sense a button input made by the user when the horizontal and vertical input signal lines 1370 and 1380 are connected to the metallic plate 1320 and the conductive medium 1350, and receives the button input made by the user.

FIGS. 11A and 11B regard a display button input operation according to an embodiment of the present invention. FIGS. 11A and 11B are side views of the display button illustrated in FIG. 10, as seen from direction A of FIG. 10.

Specifically, FIG. 11A illustrates the situation before a user presses a display button. Referring to FIG. 11A, the horizontal input signal line 1370 is positioned at the bottom of the metallic plate 1320 and is separated from the conductive medium 1350 by a predetermined gap. The vertical input signal line 1380 is positioned between the conductive medium 1350 and the bottom plate 1360, and is electrically connected to the conductive medium 1350.

FIG. 11B illustrates the situation when the user presses the display button. Referring to FIG. 11B, when the user presses the display button, the metallic plate 1320 that supports the display button buckles so that the display button is pressed down with a feeling of a click, and the metallic plate 1320 comes in contact with the conductive medium 1350.

In this case, the horizontal input signal line 1370 is electrically connected to the conductive medium 1350. Since the conductive medium 1350 has already been connected to the vertical input signal line 1380, the horizontal input signal line 1370 and the vertical input signal line 1380 are electrically connected to each other.

Referring to FIGS. 11A and 11B, the metallic plate 1320 may serve as a signal line. Then, when the user presses the display button with his/her finger, the metallic plate 1320 is electrically connected to the conductive medium 1350 and can thus be connected to the vertical input signal line 1380. In this case, the horizontal input signal line 1370 is unnecessary.

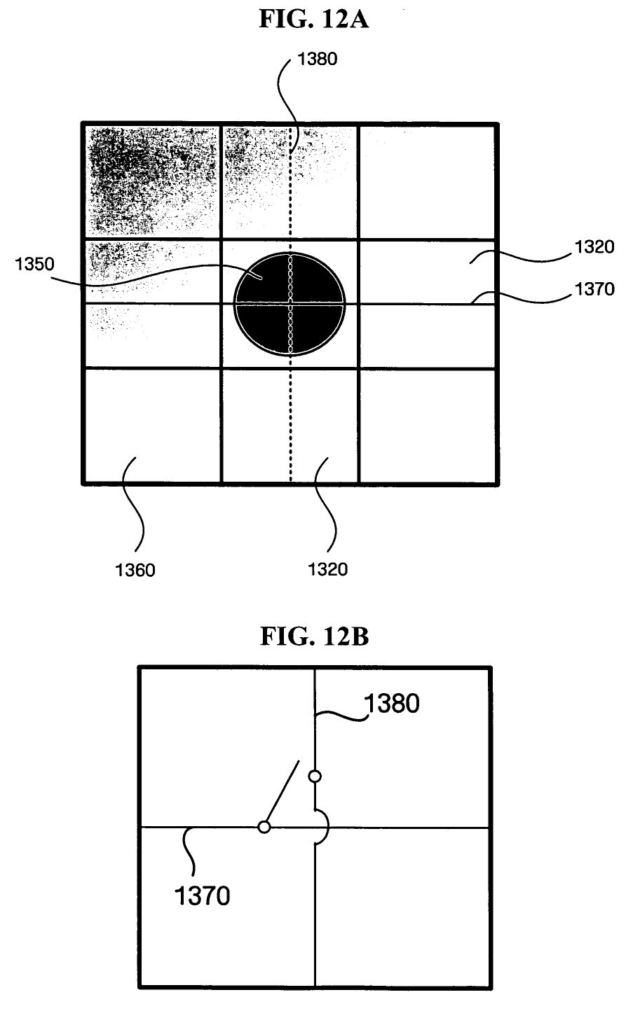

FIGS. 12A and 12B illustrate the arrangement of input signal lines to detect a display button input according to an embodiment of the present invention. Specifically, FIGS. 12A and 12B are bottom views of the display button illustrated in FIG. 10, as seen from direction B of FIG. 10.

Referring to FIG. 12A, the horizontal input signal line 1370 and the vertical input signal line 1380 intersect at right angles at the center of the conductive medium 1350. The horizontal input signal line 1370 is positioned on the metallic plate 1320, and the vertical input signal line 1380 is positioned between the conductive medium 1350 and the bottom plate 1360. FIG. 12B illustrates a switching relationship between the horizontal input signal line 1370 and the vertical input signal line 1380. Referring to FIG. 12B, when a user presses the display button, a switch is closed so that the horizontal input signal line 1370 and the vertical input signal line 1380 are electrically connected to each other.

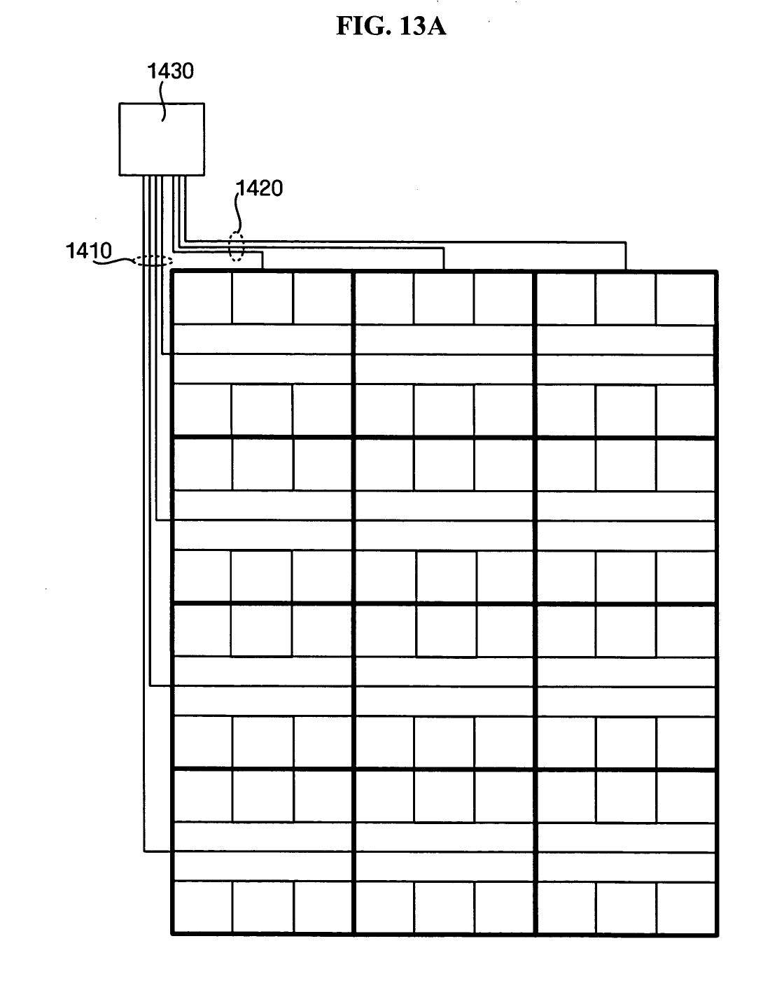

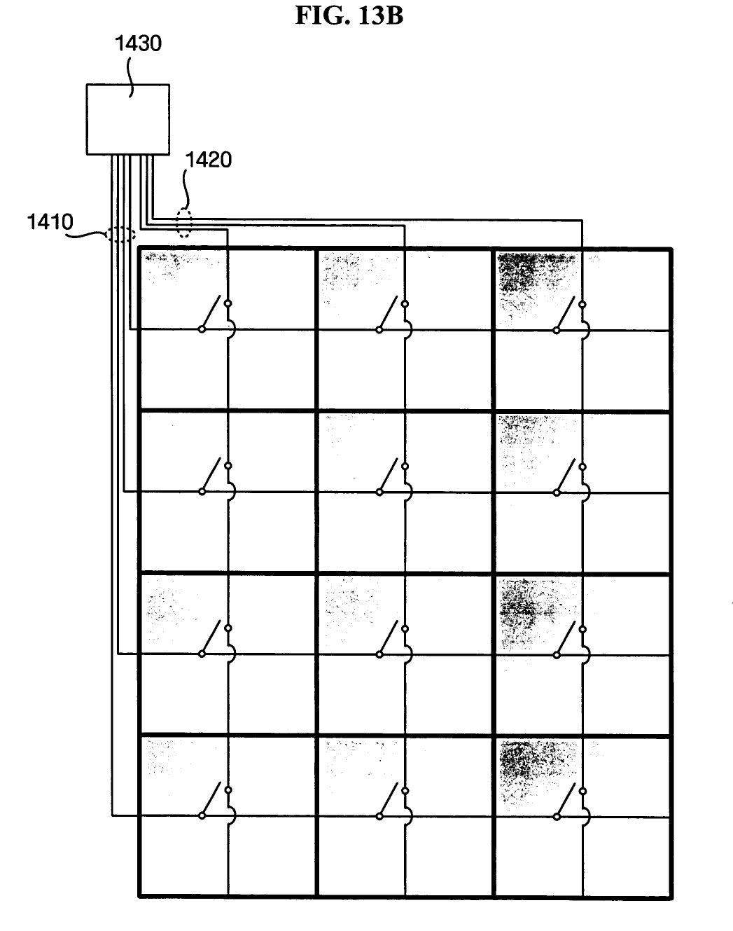

FIGS. 13A and 13B illustrate architecture to sense an input from a display array that has a plurality of display buttons according to an embodiment of the present invention. Referring to FIGS. 13A and 13B, a button input detection circuit 1430 corresponds to the input sensing module 830 or 880 illustrated in FIGS. 8A and 8B, respectively. The button input detection circuit 1430 senses user input and determines which of the display buttons has been pressed by a user. The button input detection circuit 1430 is electrically connected to a plurality of horizontal input detection signal lines 1410 and a plurality of vertical input detection signal lines 1420.

In detail, the button input detection circuit 1430 determines which of the display buttons has been pressed by the user by sequentially applying a voltage to the horizontal input detection signal lines 1410 and determining from which of the vertical input detection signal lines 1420 the voltage is detected.

In other words, the button input detection circuit 1430 sequentially applies a signal to a plurality of rows of the display array at regular time intervals, and determines which of a plurality of columns of the display array the signal is detected from. For example, when a signal is applied to a fourth row of the display array and the signal is detected from a second column of the display array, the button input detection circuit 1430 determines that the display button in the fourth row and the second column of the display array has been pressed by the user. In this manner, more than one display button input can be effectively detected. FIG. 13B is a circuit diagram of the architecture illustrated in FIG. 13A.

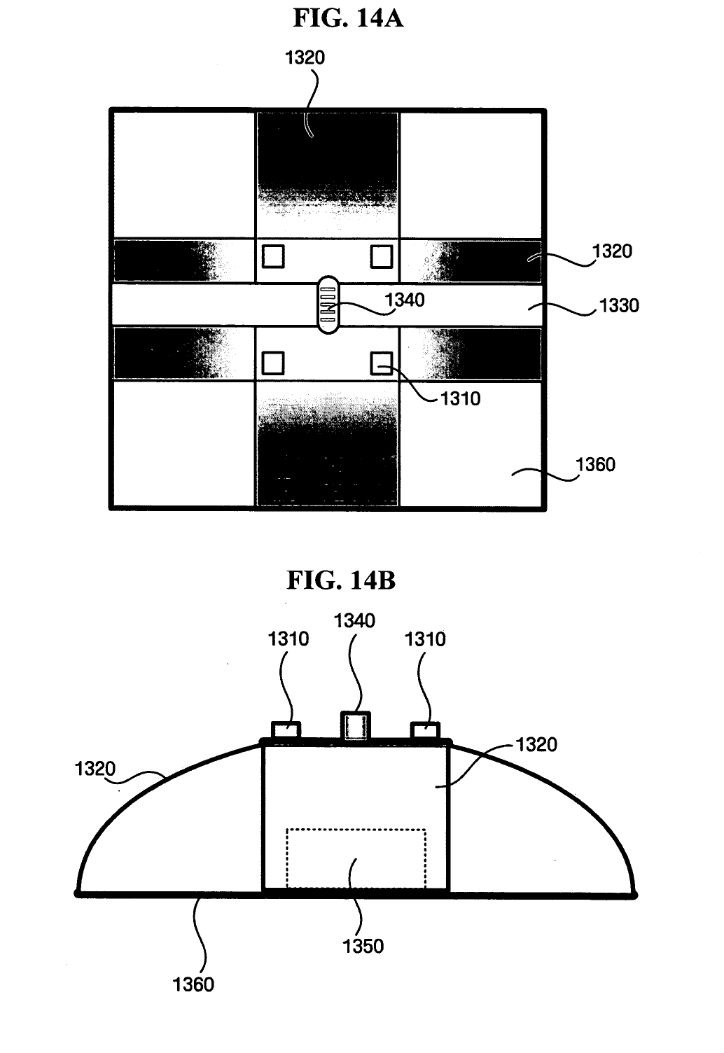

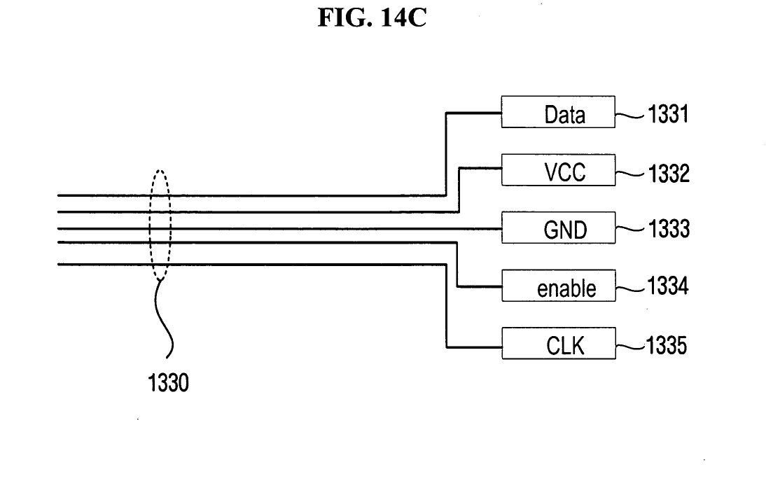

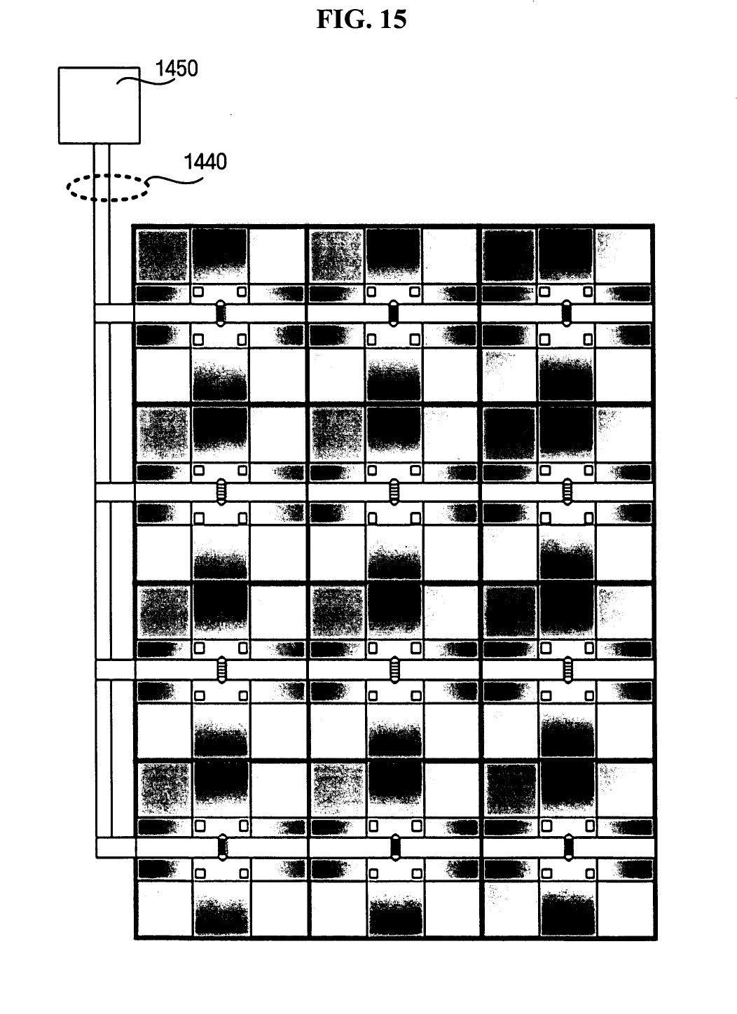

FIGS. 14 through 14C illustrate the arrangement of the image driving line 1330 illustrated in FIG. 10 according to an embodiment of the present invention. Specifically, FIG. 14A is a bottom view of the image driving line 1330 which is formed on the metallic plate 1320, as seen from direction B of FIG. 10.

Referring to FIG. 14A, the image driving line 1330 is positioned on the top surface of the metallic plate 1320. According to one embodiment, the image driving line 1330 is positioned on the top surface of a horizontal portion of the metallic plate 1320. The connector 1340 is electrically connected to a predetermined portion of the image driving line 1330, and is surrounded by the fixed protrusions 1310 that fix the button unit 1300 and the connection unit 1200. FIG. 14B is a side view of the display button illustrated in FIG. 14A, as seen from direction A of FIG. 10.

FIG. 14C illustrates the structure of the image driving line 1330 illustrated in FIG. 10. Referring to FIG. 14C. According to one embodiment, the image driving line 1330 includes five signal lines.

The five signal lines include a signal line ‘Data’ (1331) which contains information regarding an image displayed on the display button, a signal line ‘Vcc’ (1332) to supply a power supply voltage, a signal line ‘GND’ (1333) to supply a ground voltage, a signal line ‘enable’ (1334) to enable a display button, and a signal line ‘CLK’ (1335) to transmit a timing clock signal.

FIG. 15 is a plan view of architecture to provide a display array that has a plurality of display buttons to display an image according to an embodiment of the present invention. Referring to FIG. 15, according to one embodiment, the display buttons are arranged in an array.

An image display circuit 1450 transmits the same image information to all the display buttons of the display array via a signal line 1440 to display images. The signal line 1440 is electrically connected to the image driving line 1330. According to one embodiment, which of the display buttons of the display array is to be enabled is determined by the signal line ‘enable’ (1334).

The image display circuit 1450 includes the control module 810 or 860 and the graphic processing module 820 or 870, illustrated in FIG. 8A or 8B, respectively. According to one embodiment, the image display circuit 1450 also includes the decoding module 850 illustrated in FIG. 8A or the plurality of decoding modules of the display module 890 of 8B.

FIGS. 16A through 16C illustrate an image display unit 1100 of a display button according to an embodiment of the present invention, and particularly, an image display unit 1100 of an interface apparatus that includes a display array having a plurality of display buttons, each display button having a decoding module.

Referring to FIGS. 16A and 16B, the image display unit 1100 includes the image unit 1150 and the image driving unit 1160. FIG. 16B is a side view of the image display unit 1100 illustrated in FIG. 16A. The image unit 1150 includes electronic paper, which is bi-stable.

The connector 1130 is connected to the connector 1340 of the button unit 1300 through the connector connection hole 1230. A plurality of fixed grooves 1110 are positioned in the image driving unit 1160 to respectively correspond to the fixed protrusions 1210. According to one embodiment, the fixed grooves 1110 fix the image display unit 1100 and the connection unit 1200 by fitting over the respective fixed protrusions 1210. Also, a groove 1140 is positioned in the image driving unit 1160 to fix the press connector 1220.

Referring to FIG. 16C, the image driving line 1330 is connected to a driving circuit 1120 via the connector 1130 of the image display unit 1100. According to one embodiment, the driving circuit 1120 includes a decoding module. The decoding module decodes an enable signal transmitted via the signal line ‘enable’ (1334) of the image driving line 1330, thereby enabling the image driving unit 1160 so that an image can be displayed by the image unit 1150 when the display button needs to be driven.

For example, when an event that modifies display information of the display button occurs, the image display circuit 1450 transmits the same image information to all the display buttons of the display array together with an encoded enable signal corresponding to the display button via the signal line 1440.

Accordingly, even though the image information is applied to all the display buttons of the display array, the driving circuit 1120 that actually displays the image information modifies information of the image unit 1150 by driving the image driving unit 1160 only when the display button is driven by decoding the encoded enable signal.

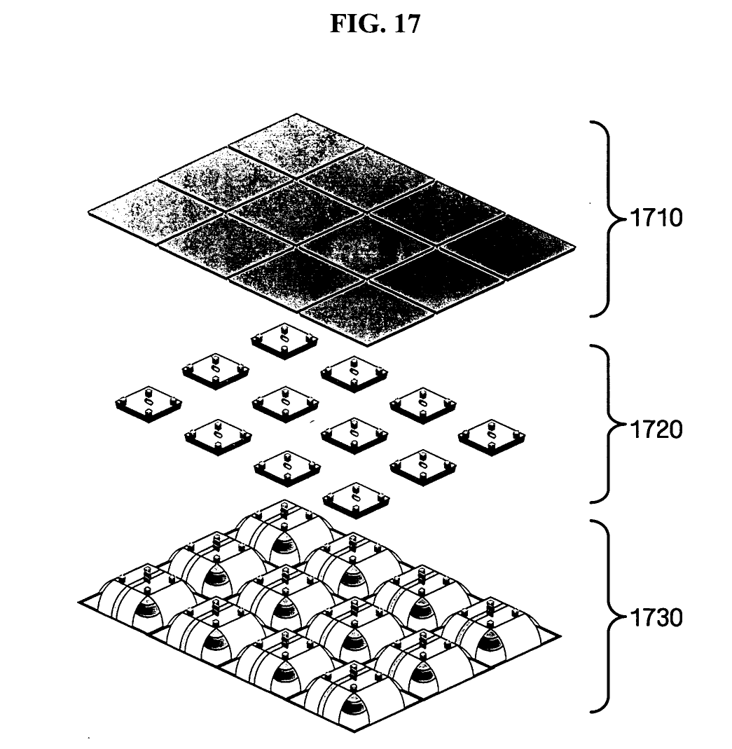

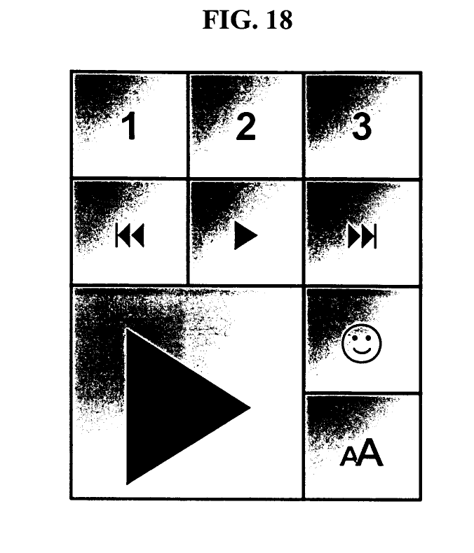

FIG. 17 is an exploded perspective view of a display array that has a plurality of display buttons according to an embodiment of the present invention. Referring to FIG. 17, a button unit 1730 includes a plurality of display buttons arranged in a matrix, and an image driving line and horizontal and vertical input signal lines are connected to the matrix. A connection unit 1720 and an image display unit 1710 are coupled to the button unit 1730.

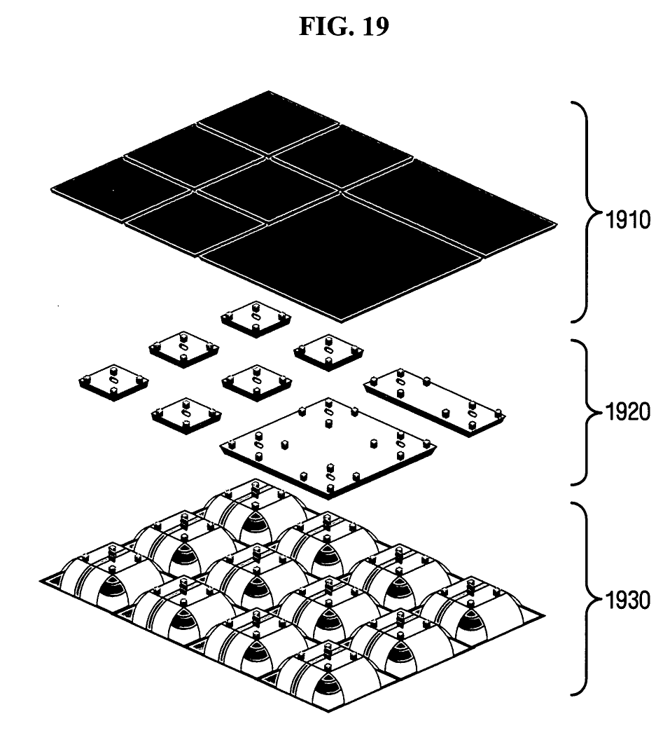

FIG. 18 illustrates a user interface using a plurality of display buttons according to an embodiment of the present invention, and FIG. 19 is an exploded perspective view of a display array that provides the user interface illustrated in FIG. 18.

Referring to FIG. 18, the display buttons can display a variety of images according to the circumstances facing the display buttons. Referring to FIG. 19, according to one embodiment, a button unit 1930 for the display buttons illustrated in FIG. 18 is formed as a matrix, and the size and shape of an image display unit 1910 and a connection unit 1920 may be altered according to the field of application.

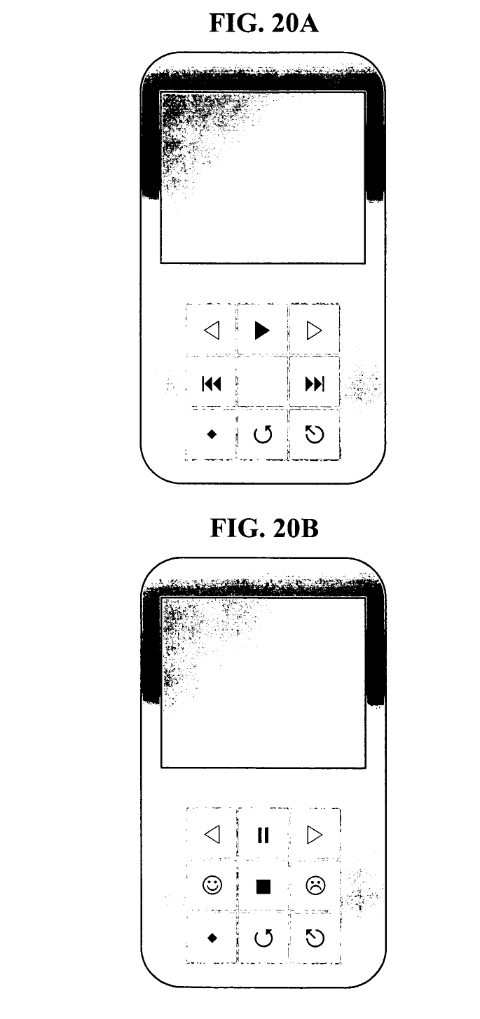

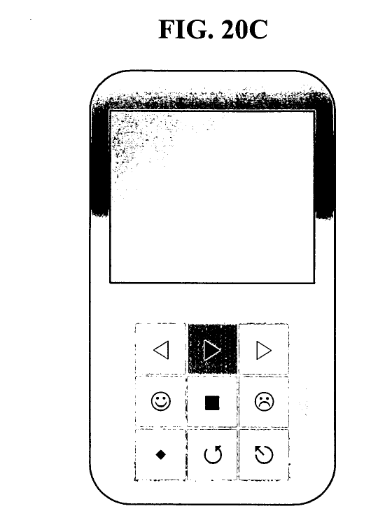

FIGS. 20A through 20C illustrate an interface apparatus using a plurality of display buttons according to another embodiment of the present invention, and particularly, an MP3 player having a user interface that uses a plurality of display buttons according to another embodiment of the present invention.

Specifically, FIG. 20A illustrates a user interface before the playback of music, FIG. 20B illustrates a user interface during the playback of music, and FIG. 20C illustrates a user interface when the playback of music is temporarily stopped. Referring to FIGS. 20A through 20C, during the playback of music, a play button [symbol] turns into a pause button (||), and a stop button (▪) appears. During the playback of music, display buttons [symbol] and [symbol] may be provided so that a user can express his/her satisfaction or dissatisfaction with the music.

As described above, according to embodiments of the present invention, it is possible to reduce the manufacture time and costs of display button devices.

In addition, according to embodiments of the present invention, it is possible to easily control image information displayed by a plurality of display buttons.

Moreover, according to embodiments of the present invention, it is possible to control a plurality of display buttons using a single graphic processing module.

Furthermore, according to embodiments of the present invention, it is possible to minimize the number of signal lines required and easily adjust the number of display arrays required.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An interface apparatus, comprising:
a display module comprising a plurality of display devices that display an image using electronic paper;
a control module, which provides enable information needed to enable the respective display devices and image information needed to display the image;
a decoding module, which decodes the enable information and sequentially transmits the decoded enable information to the display devices; and
a graphic processing module, which receives the image information from the control module and sequentially transmits the image information to the display devices,
wherein the image information is displayed by one or more of the display devices that are enabled according to the enable information.

2. The interface apparatus of claim 1, wherein the plurality of display devices comprise a plurality of display buttons.

3. An interface apparatus, comprising:
a display module comprising a plurality of display devices that display an image using electronic paper;
a control module, which provides enable information needed to enable the respective display devices and image information needed to display the image; and
a graphic processing module, which receives the image information from the control module and sequentially transmits the image information to the display devices,
wherein each of the display devices comprises a decoding module that decodes the enable information and sequentially transmits the decoded enable information to the display devices, and the image information is displayed by one or more of the display devices that are enabled according to the enable information.

4. The interface apparatus of claim 3, wherein the plurality of display devices comprise a plurality of display buttons.

5. An interface apparatus, comprising:
a display module comprising a plurality of display buttons that display an image using electronic paper and sense user input;
an input sensing module, which chooses one or more of the display buttons that are determined to have been pressed by a user according to the sensed user input;
a control module, which provides enable information needed to enable the one or more chosen display buttons and image information needed to display an image;
a decoding module, which decodes the enable information and sequentially transmits the decoded enable information to the display buttons; and
a graphic processing module, which receives the image information from the control module and sequentially transmits the image information to the display buttons, wherein the image information is displayed by one or more of the display buttons that are enabled according to the enable information.

6. The interface apparatus of claim 5, wherein each of the display buttons comprises:
a button unit, which senses the user input;
an image display unit, which displays image information corresponding to the user input on the electronic paper; and
a connection unit, which connects the button unit and the image display unit.

7. The interface apparatus of claim 6, wherein the button unit comprises:
a metallic plate, which extends in four directions across the center of the button unit and transmits a press feedback to the user when the button unit is pressed down by the user; and
an image driving line, which transmits the image information to the image display unit, positioned on the metallic plate.

8. The interface apparatus of claim 7, wherein the button unit further comprises a conductive medium, which receives the user input by being placed in contact with the metallic plate.

9. The interface apparatus of claim 8, wherein the button unit further comprises:
a first input signal line positioned on the metallic plate; and
a second input signal line positioned on the conductive medium,
wherein the button unit senses the user input by detecting whether the first and second signal lines are electrically connected via the metallic plate and the conductive medium.

10. The interface apparatus of claim 6, wherein the connection unit comprises:
a press connector, which alleviates shock generated when the button unit is pressed down; and
a plurality of fixed protrusions, which fix the press connector and the image display unit,
wherein the connection unit has an empty space provided for transmitting the image information from the button unit to the image display unit.

11. The interface apparatus of claim 6, wherein the image display unit comprises:
an image unit, which displays the image information on the electronic paper; and
an image driving unit, which drives the image unit.

12. An interface apparatus, comprising:
a display module comprising a plurality of display buttons that display an image using electronic paper and sense user input;
an input sensing module, which chooses one or more of the display buttons that are determined to have been pressed by a user according to the sensed user input;
a control module, which provides enable information needed to enable the one or more chosen display buttons and image information needed to display an image; and
a graphic processing module, which receives the image information from the control module and sequentially transmits the image information to the display buttons,
wherein
each of the display buttons comprises a decoding module that decodes the enable information and sequentially transmits the decoded enable information to the display buttons, and
the image information is displayed by one or more of the display buttons that are enabled according to the enable information.

13. The interface apparatus of claim 12, wherein each of the display buttons comprises:
a button unit, which senses the user input;
an image display unit, which displays image information corresponding to the user input on the electronic paper; and
a connection unit, which connects the button unit and the image display unit.

14. The interface apparatus of claim 13, wherein the button unit further comprises:
a metallic plate, which extends in four directions across the center of the button unit and transmits a press feedback to the user when the button unit is pressed down by the user; and
an image driving line, which transmits the image information to the image display unit, positioned on the metallic plate.

15. The interface apparatus of claim 14, wherein the button unit comprises a conductive medium which receives the user input by being placed in contact with the metallic plate.

16. The interface apparatus of claim 15, wherein the button unit further comprises:
a first input signal line positioned on the metallic plate; and
a second input signal line positioned on the conductive medium,
wherein the button unit senses the user input by detecting whether the first and second signal lines are electrically connected via the metallic plate and the conductive medium.

17. The interface apparatus of claim 13, wherein the connection unit comprises:
a press connector, which alleviates shock generated when the button unit is pressed down; and
a plurality of fixed protrusions, which fix the press connector and the image display unit,
wherein the connector unit has an empty space provided for transmitting the image information from the button unit to the image display unit.

18. The interface apparatus of claim 13, wherein the image display unit comprises:
an image unit, which displays the image information on the electronic paper; and
an image driving unit, which drives the image unit.

19. An interface apparatus comprising:
a button unit, which senses user input;
an image display unit, which displays image information corresponding to the sensed user input on electronic paper; and
a connection unit, which connects the button unit and the image display unit.

20. The interface apparatus of claim 19, wherein the button unit comprises:
a metallic plate, which extends in four directions across the center of the button unit and transmits a press feedback to the user when the button unit is pressed down by the user; and
an image driving line, which transmits the image information to the image display unit, positioned on the metallic plate.

21. The interface apparatus of claim 20, wherein the button unit comprises a conductive medium, which receives the user input by being placed in contact with the metallic plate.

22. The interface apparatus of claim 21, wherein the button unit further comprises:
a first input signal line positioned on the metallic plate; and
a second input signal line positioned on the conductive medium,
wherein the button unit senses the user input by detecting whether the first and second signal lines are electrically connected via the metallic plate and the conductive medium.

23. The interface apparatus of claim 19, wherein the connection unit comprises:
a press connector, which alleviates shock generated when the button unit is pressed down; and
a plurality of fixed protrusions which fix the press connector and the image display unit,
wherein the connector unit has an empty space provided for transmitting the image information from the button unit to the image display unit.

24. The interface apparatus of claim 19, wherein the image display unit comprises:
an image unit, which displays the image information on the electronic paper; and
an image driving unit, which drives the image unit.

25. The interface apparatus of claim 24, wherein the image driving unit decodes a predetermined display button select signal to decide whether to display the image information with the aid of the image unit.

26. An interface apparatus, comprising:
a display array, which comprises a plurality of display buttons that display image information using electronic paper;
an input sensing module, which determines which of the display buttons is selected by a user; and
an image display circuit, which provides the display array with
image information corresponding to the display button that is determined to be selected by the user, and
a select signal to select the display button that is determined to be selected by the user.

27. The interface apparatus of claim 26, wherein each of the display buttons comprises:
a button unit, which senses user input and transmits the sensed user input to the input sensing module;
an image display unit, which displays the image information on the electronic paper; and
a connection unit, which connects the button unit and the image display unit.

28. The interface apparatus of claim 27, wherein the button unit comprises:
a metallic plate, which extends in four directions across the center of the button unit and transmits a press feedback to the user when the button unit is pressed down by the user; and
an image driving line, which transmits the image information and the select signal to the image display unit, positioned on the metallic plate.

29. The interface apparatus of claim 27, wherein the image display unit comprises:
an image unit, which displays the image information on the electronic paper; and
an image driving unit, which drives the image unit and decodes the select signal.

30. An interface method, comprising:
sensing user input from a plurality of display buttons that display an image using electronic paper, and selecting one or more of the display buttons that are pressed by a user;
sequentially providing enable information needed to enable the selected display buttons to the display buttons; and
sequentially providing image information needed to display a predetermined image to the display devices, and displaying the image information on one or more of the display buttons that are enabled according to the enable information.

31. The interface method of claim 30, wherein sequentially providing the enable information needed to enable the selected display buttons to the display buttons, comprises decoding the enable information and sequentially providing the decoded enable information to the display buttons.

32. An interface method, comprising:
providing enable information needed to enable one or more of a plurality of display devices and image information needed to display an image, the display devices displaying the image using electronic paper;
decoding the enable information and sequentially transmitting the decoded enable information to the display devices; and
displaying the image information on the one or more of the display devices that are enabled according to the decoded enable information.

33. The interface method of claim 32, wherein the plurality of display devices comprise a plurality of display buttons.

34. An interface method, comprising:
providing enable information needed to enable one or more of a plurality of display devices and image information needed to display an image, the display devices displaying the image using electronic paper;
decoding the enable information;
sequentially transmitting the image information to the display devices; and
displaying the image information on the one or more of the display devices that are enabled according to the decoded enable information.

35. The interface method of claim 34, wherein the plurality of display devices comprise a plurality of display buttons.
